(19) United States
(12) Patent Application Publication
(10) Pub. No.: US 2016/0031097 A1
(43) Pub. Date: Feb. 4, 2016

(54) CUTTER ASSEMBLY HAVING A LIMITING STRUCTURE

(71) Applicant: SDI Corporation, Chang Hua (TW)

(72) Inventor: Chien-Lung Wu, Chang Hua (TW)

(21) Appl. No.: 14/449,426

(22) Filed: Aug. 1, 2014

(51) Int. Cl. B26B 5/00; B26B 1/08

(52) U.S. Cl. CPC B26B 5/006; B26B 1/08

(57) ABSTRACT

A cutter assembly has a blade holder, a blade and a limiting element. The blade holder has an elongated blade chamber defined along a longitudinal direction of the blade holder and an opening defined in one end of the blade holder and communicating with the blade chamber. The blade is moveably mounted in the blade chamber. The limiting element is mounted on the blade holder at a position adjacent to the opening and has a limiting segment extending into the blade chamber and abutting a side surface of the blade.

### BACKGROUND OF THE INVENTION

1. Field of the Invention

The present invention relates to a cutter assembly, and more particularly to a cutter assembly having a limiting structure to prevent an offset of a blade.

2. Description of Related Art

A retractable cutter substantially comprises a blade holder, a blade and a slider. The slider is mounted moveably on the blade holder. The blade is mounted slidably in the blade holder and is connected to the slider. When the slider is pushed, the blade is moved relative to the blade holder to extend out of or to retract into the blade holder.

However, the blade is connected with the slider at one end of the blade, while the other part of the blade is not connected to the blade holder or other components of the cutter assembly. Therefore, offset of the blade easily occurs during the operation of the cutter assembly, particularly at a distal end of the blade opposite to the slider. The distal end of the blade is most away from the slider and is applied to cut an object. Vibration at the distal end of the blade easily occurs, such that the conventional cutter assembly cannot be applied to a fine cutting process stably and accurately.

To overcome the shortcomings, the present invention tends to provide a cutter assembly to mitigate or obviate the aforementioned problems.

### SUMMARY OF THE INVENTION

The main objective of the invention is to provide a cutter assembly having a limiting structure to prevent an offset of a blade so as to improve the operation stability of the blade.

The cutter assembly in accordance with the present invention has a blade holder, a blade and a limiting element. The blade holder has an elongated blade chamber defined along a longitudinal direction of the blade holder and an opening defined in one end of the blade holder and communicating with the blade chamber. The blade is moveably mounted in the blade chamber. The limiting element is mounted on the blade holder at a position adjacent to the opening and has a limiting segment extending into the blade chamber and abutting a side surface of the blade.

With the aforementioned feature, the offset of a distal end of the blade can be effectively limited by the abutment between the side surface of the blade and the limiting segment of the limiting element that is adjacent to the opening of the blade holder. The operation stability of the blade can be improved to conduct a fine cutting process. Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a cutter assembly in accordance with the present invention;

FIG. 2 is an enlarged end view in partial section of the cutter assembly in FIG. 1;

FIG. 3 is an enlarged side view in partial section of the cutter assembly along line 3-3 in FIG. 2;

FIG. 4 is an enlarged top view in partial section of the cutter assembly in FIG. 1;

FIG. 5 is an enlarged side view of a second embodiment of a cutter assembly in accordance with the present invention;

FIG. 6 is an enlarged side view in partial section of the cutter assembly in FIG. 5;

FIG. 7 is an exploded perspective view of the cutter assembly in FIG. 5;

FIG. 8 is an enlarged top view in partial section of the cutter assembly in FIG. 5;

FIG. 9 is an exploded perspective view of a third embodiment of a cutter assembly in accordance with the present invention; and

FIG. 10 is an enlarged top view in partial section of the cutter assembly in FIG. 9.

### DETAILED DESCRIPTION OF PREFERRED EMBODIMENT

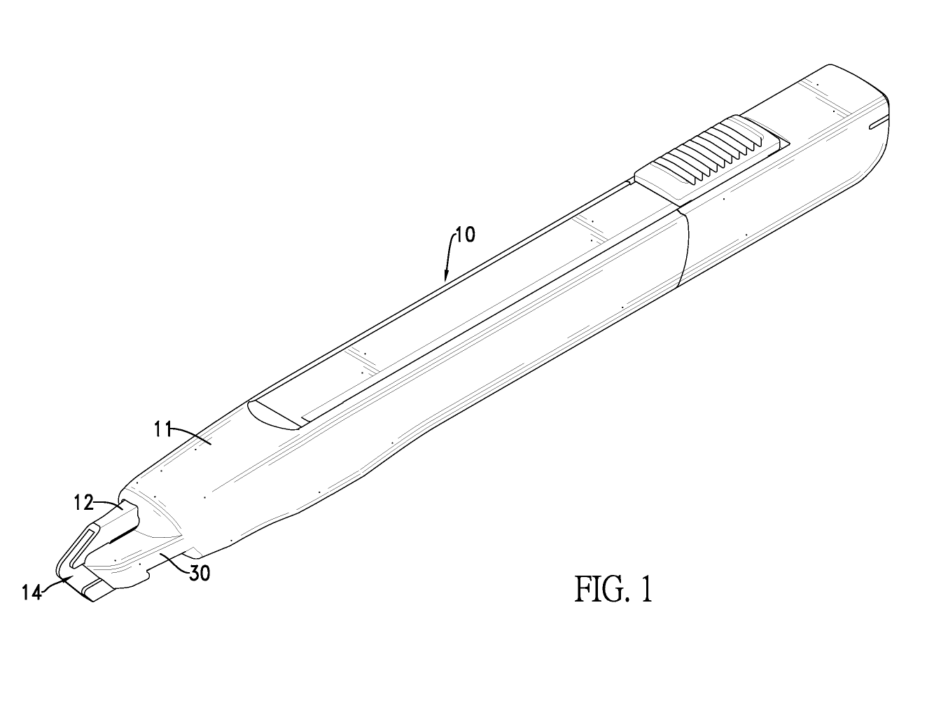

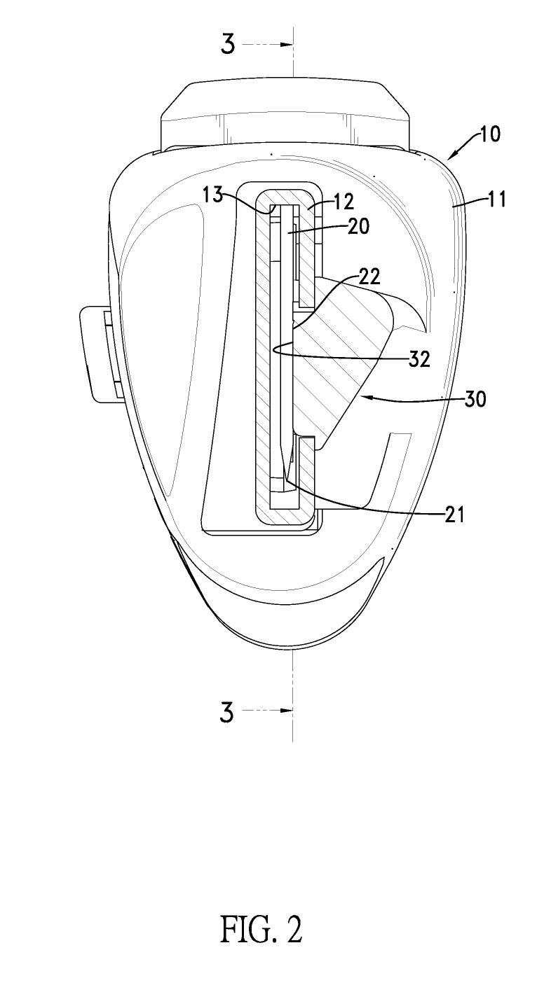

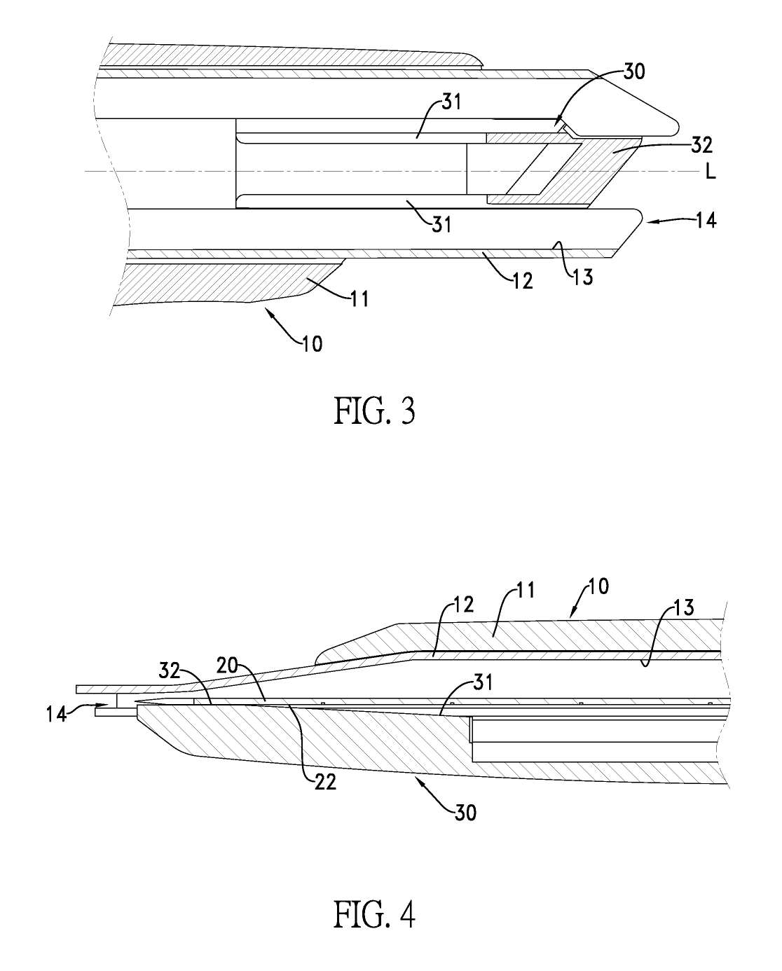

With reference to FIGS. 1 to 4, a first embodiment of a cutter assembly in accordance with the present invention comprises a blade holder 10, a blade 20 and a limiting element 30.

The blade holder 10 comprises a holder body 11 and a blade base 12. The holder body 11 has a first end and a second end. The blade base 12 is mounted in and through the holder body 11 and has an end protruding from the first end of the holder body 11. An opening 14 is defined in the end of the blade base 12 and is adjacent to the first end of the holder body 11. An elongated blade chamber 13 is defined in the holder body 11 and the blade base 12 and extends along a longitudinal direction L of the blade holder 10. The blade chamber 13 communicates with the opening 14. In a preferred embodiment, the blade base 12 is made of metal. The blade 20 is moveably mounted in the blade chamber 13 and has a cutting edge 21 formed on a bottom of the blade 20 and a distal end adjacent to the opening 14.

The limiting element 30 protrudes longitudinally from the first end of the holder body 11 at a position adjacent to the opening 14. In the first embodiment, the limiting element 30 is integrally formed on the holder body 11 as a single part. The limiting element 30 has two side edges abutting the blade base 12 and partially extends into the blade base 12. The limiting element 30 has a limiting segment 32 extending into the blade chamber 13 and abutting a side surface 22 of the blade 20. The limiting segment 32 has a limiting surface and is adjacent to the opening 14. Preferably, the limiting surface is a flat surface and is substantially parallel with the side surface 22 of the blade 20 to abut the side surface 22 of the blade 20.

The limiting element 30 further has a guiding segment 31 formed at a side of the limiting segment 32 away from the opening 14 to guide the blade 20 to the limiting segment 32. In the first embodiment, the guiding segment 31 comprises an inclined guiding surface formed on the limiting element 30, extending toward the opening 14, connected with the limiting surface, and extending into the blade chamber 13. The inclined surface has two ends, and the end of the inclined surface adjacent to the opening 14 extends more deeply into the blade chamber 13 than the end of the inclined surface away from the opening 14.

In the first embodiment, the limiting element 30 is made of, but is not limited to, plastic material.

To cut an object, the blade 20 is pushed to extend out of the blade holder 10, and the distal end of the blade 20 will be firstly in contact with the inclined surface of the guiding segment 31. The blade 20 will move gradually and deeply into the blade chamber 13 along the inclined surface and is guided to the limiting segment 32. Consequently, the distal end of the blade 20 moves to the limiting segment 32 and extends out of the blade holder 10 to a desired length by keeping abutting the limiting segment 32. Because the limiting segment 32 is adjacent to the opening 14, the distal end of the blade 20 is near the limiting segment 32. Accordingly, when the blade 20 is cutting, the offset of the blade 20 can be effectively limited by the abutment of the limiting segment 32 and the blade 20 at a position near the distal end of the blade 20. Thus, the operation stability of the blade 20 is enhanced, and a fine cutting process can be applied. In addition, the guiding and buffering effects provided by the guiding segment 31 can improve the smoothness of the movement of the blade 20, and the blade 20 can be smoothly moved to a space between the limiting segment 32 and a bottom of the blade chamber 13.

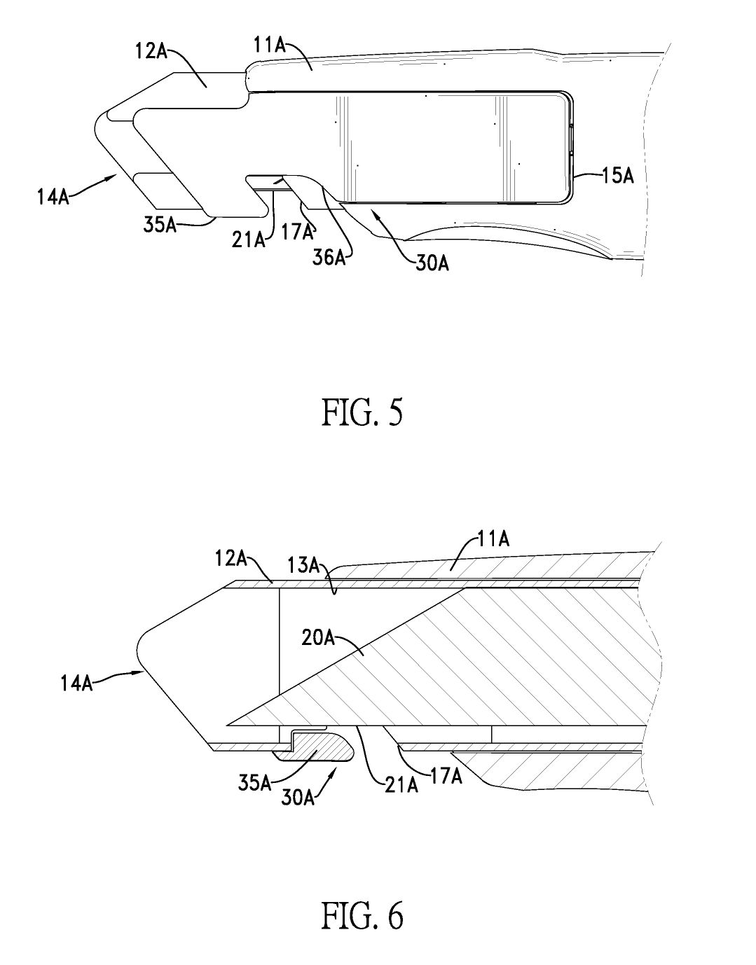

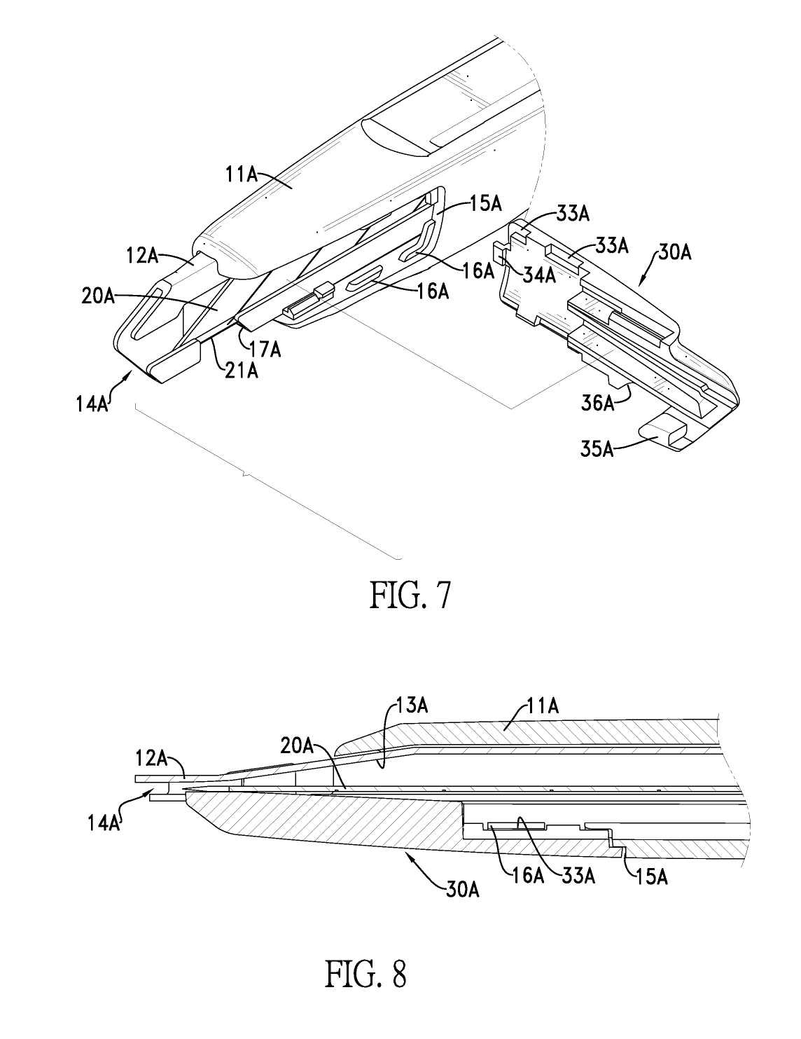

With reference to FIGS. 5 to 8, a second embodiment of the cutter assembly in accordance with the present invention, the structure of the second embodiment is substantially the same as that of the first embodiment. The holder body 11 A further has a mounting recess 15A defined through a side wall of the holder body 11A, extending to the first end of the holder body 11A, and communicating with the blade chamber 13A. The mounting recess 15A has multiple engaging blocks 16A formed on an edge around the mounting recess 15A and arranged at intervals. The limiting element 30A is not an integral part of the holder body 11A, and is attached to the holder body 11A and covers the mounting recess 15A. Multiple engaging recesses 33A are defined in an edge around a side surface of the limiting element 30A facing the holder body 11A and engage respectively the engaging blocks 16A. An engaging segment 34A is formed on an end of the limiting element 30A opposite to the opening 14A and abuts and engages an inner surface of the holder body 11A. Accordingly, the limiting element 30A is stably combined with the holder body 11A. In addition, the limiting element 30A further has an abutting block 35A extending into the blade chamber 13A, extending toward the cutting edge 21A of the blade 20A, and located below the cutting edge 21A. The abutting block 35A is closer to the cutting edge 21A than a bottom of an inner surface of the blade base 12A is. With the abutting block 35A, the cutting edge 21A of the blade 20A can be kept from contact with the metal blade base 12A to avoid friction that may affect the sharpness of the cutting edge 21A. Because the limiting element 30A and the abutting block 35A are made of plastic, the influence on the sharpness of the cutting edge 21A can be reduced even when the cutting edge 21A is in contact with the abutting block 35A.

In addition, the blade base 12A further has a notch 17A defined in a bottom of the blade base 12A, and the cutting edge 21A of the blade 20A is exposed from the notch 17A. The limiting element 30A further has a notch 36A defined in a bottom of the limiting element 30A and communicating with the notch 17A in the blade base 12A. Accordingly, the cutting edge 21A exposed from the notches 17A, 36A in the blade base 12A and the limiting element 30A can be applied to cut off a packing belt or a rope. Because the blade 20A is enclosed inside the blade base 12A and the limiting element 30A, the fingers of a user can be kept from inadvertently touching the cutting edge 21A and from being injured.

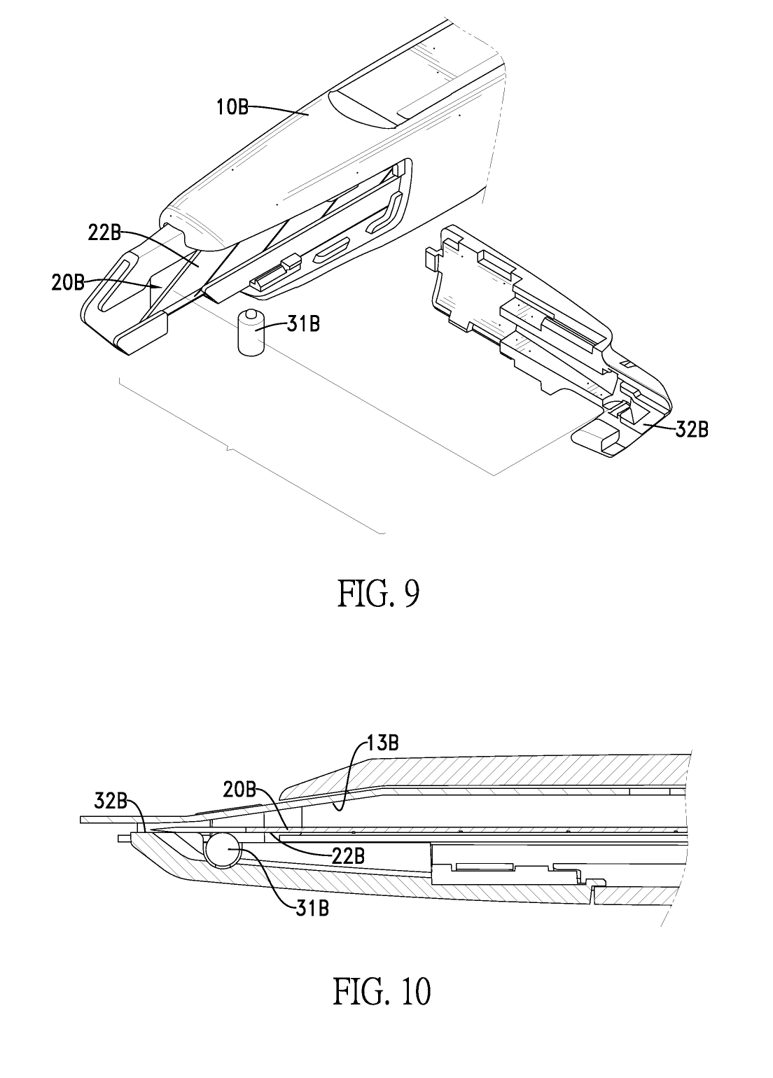

With reference to FIGS. 9 and 10, a third embodiment of the cutter assembly in accordance with the present invention, the structure of the third embodiment is substantially the same as that of the second embodiment. In the third embodiment, the guiding segment 31B comprises a roller. Preferably, the guiding segment 31B is a roller. Alternatively, the guiding segment 31B comprises a roller and an inclined guiding surface. The roller extends into the blade chamber 13B and is provided for abutting a side surface 22B of the blade 20B. When the blade 20B is pushed to extend out of the blade holder 10B, the distal end of the blade 20B will be in contact with the roller and push the roller to rotate. The distal end of the blade 20B will move gradually and deeply into the blade chamber 13B with the rotation of the roller and is guided to the limiting segment 32B. With the abutment between the limiting segment 32B and the blade 20B at a position near the distal end of the blade 20B, the offset of the distal end of the blade 20B can be effectively limited. The operation stability of the blade 20B can be improved to conduct a fine cutting process.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A cutter assembly comprising:
a blade holder having an elongated blade chamber defined along a longitudinal direction of the blade holder and an opening defined in one end of the blade holder and communicating with the blade chamber;
a blade moveably mounted in the blade chamber; and
a limiting element mounted on the blade holder at a position adjacent to the opening and having a limiting segment extending into the blade chamber and abutting a side surface of the blade.

2. The cutter assembly as claimed in claim 1, wherein the limiting segment has a limiting surface provided for abutting the side surface of the blade.

3. The cutter assembly as claimed in claim 2, wherein the blade holder comprises a holder body and a blade base;
the holder body has a first end and a second end;
the blade base is mounted in the holder body and has an end protruding from the first end of the holder body;
the opening is defined in the end of the blade base and is adjacent to the first end of the holder body;
the blade chamber is defined in the holder body and the blade base; and
the limiting element protrudes longitudinally from the first end of the holder body and partially extends into the blade base.

4. The cutter assembly as claimed in claim 3, wherein the limiting element has two side edges abutting the blade base.

5. The cutter assembly as claimed in claim 4, wherein the limiting element further has a guiding segment at a side of the limiting segment away from the opening to guide the blade to the limiting segment.

6. The cutter assembly as claimed in claim 5, wherein the limiting surface is a flat surface and is substantially parallel with the side surface of the blade.

7. The cutter assembly as claimed in claim 5, wherein the guiding segment comprises an inclined guiding surface formed on the limiting element, connected with the limiting surface, extending into the blade chamber, and having two ends; and
the end of the inclined surface adjacent to the opening extends more deeply into the blade chamber than the end of the inclined surface away from the opening.

8. The cutter assembly as claimed in claim 6, wherein the guiding segment comprises an inclined guiding surface formed on the limiting element, connected with the limiting surface, extending into the blade chamber, and having two ends; and
the end of the inclined surface adjacent to the opening extends more deeply into the blade chamber than the end of the inclined surface away from the opening.

9. The cutter assembly as claimed in claim 5, wherein the guiding segment comprises a roller extending into the blade chamber.

10. The cutter assembly as claimed in claim 6, wherein the guiding segment comprises a roller extending into the blade chamber.

11. The cutter assembly as claimed in claim 5, wherein the limiting element further has an abutting block extending into the blade chamber, extending toward a cutting edge of the blade, and located below the cutting edge, and the abutting block is closer to the cutting edge than a bottom of an inner surface of the blade holder is.

12. The cutter assembly as claimed in claim 11, wherein the blade holder further has a mounting recess defined through a side wall of the blade holder and communicating with the blade chamber; and
the limiting element is attached to the blade holder and covers the mounting recess.

13. The cutter assembly as claimed in claim 12, wherein the mounting recess has multiple engaging blocks formed on an edge around the mounting recess; and
the limiting element further has multiple engaging recesses defined in an edge around a side surface of the limiting element facing the blade holder and engaging respectively the engaging blocks.

14. The cutter assembly as claimed in claim 13, wherein the limiting element further has an engaging segment formed on an end of the limiting element opposite to the opening and abutting and engaging the inner surface of the blade holder.

15. The cutter assembly as claimed in claim 14, wherein the blade holder further has a notch defined in the blade holder; and
the limiting element further has a notch defined in the limiting element and communicating with the notch in the blade holder.

16. The cutter assembly as claimed in claim 11, wherein the limiting element is integrally formed on the blade holder as a single part.

17. The cutter assembly as claimed in claim 16, wherein the blade holder further has a notch defined in the blade holder; and
the limiting element further has a notch defined in the limiting element and communicating with the notch in the blade holder.

18. The cutter assembly as claimed in claim 1, wherein the limiting element further has an abutting block extending into the blade chamber, extending toward a cutting edge of the blade, and located below the cutting edge, and the abutting block is closer to the cutting edge than a bottom of an inner surface of the blade holder is.

19. The cutter assembly as claimed in claim 18, wherein the blade holder further has a mounting recess defined through a side wall of the blade holder and communicating with the blade chamber; and
the limiting element is attached to the blade holder and covers the mounting recess.

20. The cutter assembly as claimed in claim 19, wherein the mounting recess has multiple engaging blocks formed on an edge around the mounting recess; and
the limiting element further has multiple engaging recesses defined in an edge around a side surface of the limiting element facing the blade holder and engaging respectively the engaging blocks.

21. The cutter assembly as claimed in claim 18, wherein the limiting element is integrally formed on the blade holder as a single part.

22. The cutter assembly as claimed in claim 18, wherein the blade holder further has a notch defined in the blade holder; and
the limiting element further has a notch defined in the limiting element and communicating with the notch in the blade holder.

23. The cutter assembly as claimed in claim 1, wherein the blade holder comprises a holder body and a blade base;
the holder body has a first end and a second end;
the blade base is mounted in and through the holder body and has an end protruding from the first end of the holder body;
the opening is defined in the end of the blade base and is adjacent to the first end of the holder body;
the blade chamber is defined in the holder body and the blade base; and
the limiting element protrudes longitudinally from the first end of the holder body and partially extends into the blade base.

24. The cutter assembly as claimed in claim 23, wherein the limiting element has two side edges abutting the blade base.

25. The cutter assembly as claimed in claim 1, wherein the limiting element further has a guiding segment at a side of the limiting segment away from the opening to guide the blade to the limiting segment.

26. The cutter assembly as claimed in claim 25, wherein the guiding segment comprises an inclined guiding surface formed on the limiting element, connected with the limiting surface, extending into the blade chamber, and having two ends; and
the end of the inclined surface adjacent to the opening extends more deeply into the blade chamber than the end of the inclined surface away from the opening.

27. The cutter assembly as claimed in claim 25, wherein the guiding segment comprises a roller extending into the blade chamber.

28. The cutter assembly as claimed in claim 3, wherein the limiting element further has a guiding segment at a side of the limiting segment away from the opening to lead the blade to the limiting segment.

29. The cutter assembly as claimed in claim 28, wherein the guiding segment comprises an inclined surface formed on the limiting element, connected with the limiting surface, extending into the blade chamber, and having two ends; and
the end of the inclined surface adjacent to the opening extends more deeply into the blade chamber than the end of the inclined surface away from the opening.

30. The cutter assembly as claimed in claim 28, wherein the guiding segment comprises a roller extending into the blade chamber.

31. The cutter assembly as claimed in claim 2, wherein the limiting surface is a flat surface and is substantially parallel with the side surface of the blade.

32. The cutter assembly as claimed in claim 1, wherein the blade holder further has a mounting recess defined through a side wall of the blade holder and communicating with the blade chamber; and
the limiting element is attached to the blade holder and covers the mounting recess.

33. The cutter assembly as claimed in claim 32, wherein the mounting recess has multiple engaging blocks formed on an edge around the mounting recess; and
the limiting element further has multiple engaging recesses defined in an edge around a side surface of the limiting element facing the blade holder and engaging respectively the engaging blocks.

34. The cutter assembly as claimed in claim 5, wherein the blade holder further has a mounting recess defined through a side wall of the blade holder and communicating with the blade chamber; and
the limiting element is attached to the blade holder and covers the mounting recess.

35. The cutter assembly as claimed in claim 34, wherein the mounting recess has multiple engaging blocks formed on an edge around the mounting recess; and
the limiting element further has multiple engaging recesses defined in an edge around a side surface of the limiting element facing the blade holder and engaging respectively the engaging blocks.

36. The cutter assembly as claimed in claim 1, wherein the limiting element is integrally formed on the blade holder as a single part.

37. The cutter assembly as claimed in claim 5, wherein the limiting element is integrally formed on the blade holder as a single part.
